(19) United States
(12) Patent Application Publication
(10) Pub. No.: US 2026/0169898 A1
(43) Pub. Date: Jun. 18, 2026

(54) FILTERING TESTS BASED ON TAGS

(71) Applicant: Hewlett Packard Enterprise Development LP, Spring, TX (US)

(72) Inventor: Gavin Brebner, St. Martin D'Uriage (FR)

(21) Appl. No.: 19/044,481

(22) Filed: Feb. 3, 2025

(30) Foreign Application Priority Data
Dec. 17, 2024 (EP) 24307140.4

(51) Int. Cl. G06F 11/3668

(52) U.S. Cl. CPC G06F 11/3676; G06F 11/3688; G06F 11/3692

(57) ABSTRACT

In some examples, a system produces tags based on a plurality of tests run in a computing system including program components, where each tag of the tags indicates a relevance of a respective test to a corresponding program component in the computing system. The system receives an indication of at least one changed program component from among a plurality of program components executable in the computing system, and the system filters the plurality of tests based on the tags and the at least one changed program component to identify a subset of tests from among the plurality of tests. The system triggers performance of the subset of tests in the computing system.

### BACKGROUND

A computing system can execute program components in various parts of the computing system. For example, the computing system may include a cluster of compute nodes on which respective program components are executed. The program components in the computing system can interact with one another during execution.

### BRIEF DESCRIPTION OF THE DRAWINGS

Some implementations of the present disclosure are described with respect to the following figures.

FIG. 1 is a block diagram of an arrangement that includes a test evaluator, a test filter, and a test executor, in accordance with some examples.

FIG. 2 is a flow diagram of a test filtering process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

When a computing system is initially deployed or after a modification of the computing system, various tests can be run to ensure that program components executed in the computing system are performing in an expected manner. The computing system may be modified frequently, such as due to program updates or re-installations. Tests are run in response to the frequent modifications. With a complex computing system with many different types of program components executed across different parts of the computing system, a suite of tests run in the computing system may include a large quantity (e.g., hundreds or thousands) of tests. As changes are made to the computing system (e.g., due to new releases of software and/or firmware), the entire suite of tests may be re-run multiple times in response to the changes. Such tests are referred to as regression tests that are run to ensure that a change made to the computing system does not produce a fault.

Tests can include integration tests that test interactions among program components. Tests can also include end-to-end (E2E) tests that include sequences of steps that may be performed by end users of the computing system. Setting up and running an entire suite of tests can take a relatively long time (many hours or days). Also, running the entire suite of tests can tie up resources of the computing system that may not be available for other operations.

In accordance with some implementations of the present disclosure, a test filtering system filters tests that are to be run in a computing system to test program components, where the filtering can be based on tags associated with the tests. A tag indicates a relevance of a test to a program component. For example, a set of tags associated with a given test indicates a relevance of the given test to program components of a computing system. For example, the set of tags can indicate the program components exercised by the respective test. As another example, the set of tags can indicate the program components not exercised by the respective test. The tags are derived based on evaluating test runs performed in the computing system.

In alternative examples, a set of tags is associated with a given program component. In such alternative examples, the tags of the set indicate the relevance of corresponding tests to the given program component. For example, a first tag of the set indicates a relevance of a first test to the given program component, a second tag of the set indicates a relevance of a second test to the given program component, and so forth.

When a change is made to the computing system, an indication of one or more changed program components can be provided to the test filtering system. The test filtering system filters the tests based on the tags and the one or more changed program components to identify a subset of tests to apply in the computing system.

Techniques or mechanisms according to some examples of the present disclosure improve computer functionality or the computer testing technology by reducing the quantity of tests that are to be run in response to changes to computing systems. A smaller quantity of tests can complete in a shorter amount of time, and running the smaller quantity of tests consumes less resources of the computing system.

As used here, a “tag” can refer to metadata relating to a relevance between a program component and a test. The tag may contain a score indicative of a relevance of a test to a corresponding program component. For example, the score may include a probability score (or any other numerical score), where a higher score assigned to a first test indicates a higher relevance of the first test to the corresponding program component as compared to a second test that is assigned a lower score. In other examples, a higher score can indicate a lower relevance of a test to a program component than a lower score. A “score” may be expressed as a numeric value or a categorical value (e.g., high, low, medium).

The “relevance” of a test to a program component indicates whether the test produced some effect on the program component. For example, a test that exercises (e.g., invokes, calls, or otherwise causes execution of) a program component is relevant to the program component. A test that does not exercise a program component is not relevant to the program component.

The usefulness of a test to a program component is an example of relevance of the test to the program component. In some examples, the usefulness of a test to a program component may be based on any or some combination of the following factors: how many times the test invoked the program component, how long the program component was running during the test, a behavior of the program component, or any other factor. A first test that exercised a program component fewer times or for a shorter duration may be less useful than a second test that exercised the program component more times or for a longer duration. A first test that caused an anomaly in a program component may be more useful than a second test that did not cause an anomaly in the program component.

A “program component” can refer to any individual executable element of program code. For example, a program component may include a micro-service or another type of service. As another example, a program component may include a function or a routine. As a further example, a program component may include a line of code or a group of lines of code of a program.

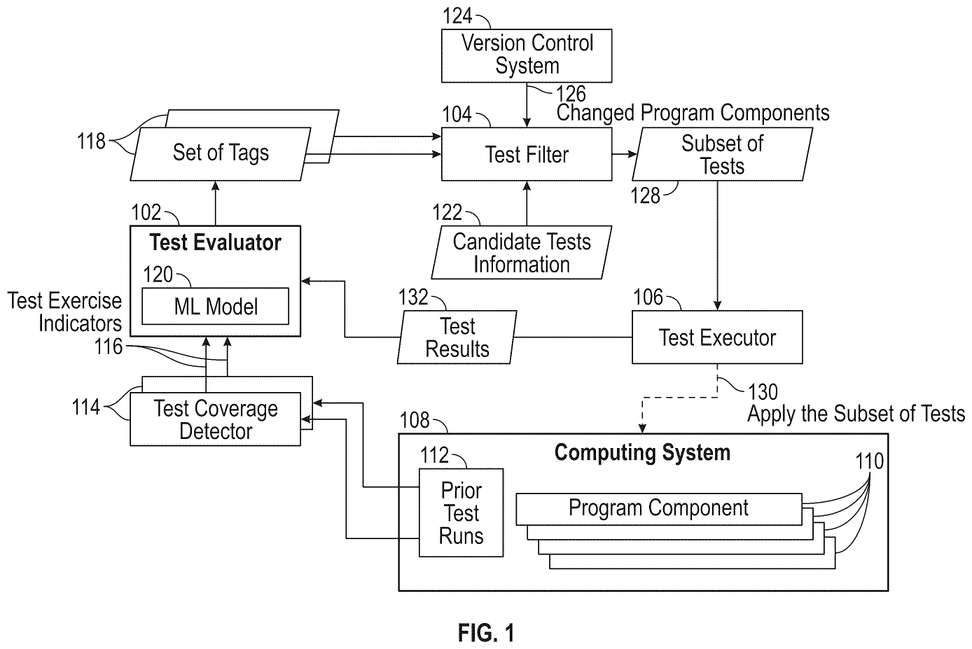

FIG. 1 is a block diagram of an example arrangement that includes a test evaluator 102, a test filter 104, a test executor 106, and a computing system 108. The computing system 108 can include one or more computers. The computing system 108 can be part of a cloud computing environment, a data center, or any other type of computing environment. Although just one computing system 108 is shown in FIG. 1, in other examples, there may be multiple computing systems to which tests are applied.

The test evaluator 102, the test filter 104, and the test executor 106 can be implemented using one or more computers. For example, the test evaluator 102, the test filter 104, and the test executor 106 can include machine-readable instructions executed in the one or more computers. The test evaluator 102, the test filter 104, and the test executor 106 may be part of the computing system 108 or may be separate from the computing system 108.

Tests can be run in the computing system 108 for testing program components 110 in the computing system 108. A “test run” refers to the performance of one or more tests in the computing system 108. Multiple different tests can be run in the computing system 108.

Prior test runs 112 are test runs that were previously executed in the computing system 108. The prior test runs 112 may have exercised at least some of the program components 110.

The effect of the prior test runs 112 in the computing system 108 can be monitored by one or more test coverage detectors 114. Each test coverage detector 114 determines which program components 110 were exercised by a given test. As examples, a test coverage detector 114 can detect which functions or routines were exercised by a given test. In other examples, a test coverage detector 114 can detect which lines of code of a program were exercised by a given test. The given test may produce test exercise indicators 116 (e.g., flags, information elements, signals, etc.) as the given test exercises respective functions, routines, or lines of code. The test coverage detector(s) 114 generate(s) the test exercise indicators 116 based on monitoring the program components 110 as they are being tested by the prior test runs 112.

As further examples, a test coverage detector 114 can provide test exercise indicators 116 relating to calls of application programming interfaces (APIs) of services, such as micro-services. A test exercise indicator relating to a call of an API of a micro-service can be in the form of a system level indicator (SLI), which can include a flag or information element set to a specified value when the API of the micro-service is called by a test. SLIs can indicate the activity relating to a service during a test run.

Based on monitoring which program components were exercised by the prior test runs 112 (and the extent and/or result of the exercise of the program components), the test coverage detector(s) 114 can provide respective test exercise indicators 116 to the test evaluator 102. The test exercise indicators 116 can specify which program components were exercised by each test, and how many times or for how long the exercised program components were invoked or executed. A test exercise indicator can also provide information regarding the result of a test of a program component.

The “extent” of an exercise of a program component by a test can refer to how many times the test invoked the program component and/or how long the program component was running during the test. The “result” of an exercise of a program component by a test can refer to how the program component behaved due to the test. For example, a test exercise indicator can specify how much activity of a program component under test deviates from a background activity of the program component. As another example, a test exercise indicator can specify an execution status of the program component. The execution status can include a success status that indicates that the program component under test ran successfully to completion. Alternatively, the execution status can indicate a fault status that indicates the program component under test experienced an anomaly, such as an error, an unexpected output, or another type of unexpected behavior due to application of a test. For example, status codes indicating successful or unsuccessful execution statuses may be produced based on testing the program components 110.

The test evaluator 102 can produce tags representing the usefulness of the tests relative to the program components 110 based on the test exercise indicators 116 from the test coverage detector(s) 114. The test evaluator 102 produces multiple sets of tags 118, where each set of tags 118 is associated with a respective test. For example, a first set of tags 118 is associated with a first test, a second set of tags 118 is associated with a second test, and so forth.

In some examples, a set of tags 118 associated with a given test indicates the usefulness of the given test relative to respective program components 110. In an example, a tag may include a binary flag that is settable to a first value (e.g., “1”) to indicate that a respective program component 110 was exercised, and to a different second value (e.g., “0”) to indicate that the respective program component 110 was not exercised.

In other examples, the tags of a set of tags 118 can include non-binary values in the form of scores. A score can be a probability score or a different numerical score. Different scores indicate different levels of usefulness of a test to a respective program component 110.

In an example, a score, Score(j, k), representing the usefulness of test j with respect to program component k can be based on how much the activity of program component k deviates from the baseline activity of program component k. As a specific example, the activity of a program component can be based on a quantity of transactions (e.g., including input requests and/or output traffic) experienced by the program component. When program component k is in a “test idle mode” (i.e., no test is run against given program component k), a baseline transaction metric, Baseline_Transactions, can represent a baseline quantity of transactions experienced by program component k per unit time. The baseline metric, Baseline_Transactions, for the program component k is provided as an input to the test evaluator 102.

The test exercise indicators 116 provided by the test coverage detector(s) 114 to the test evaluator 102 can indicate a quantity of transactions per unit time experienced by program component k due to application of each test in the prior test runs 112 in the computing system 108. For example, the test exercise indicators 116 can indicate a first quantity of transactions per unit time experienced by program component k due to application of a first test, a second quantity of transactions per unit time experienced by program component k due to application of a second test, and so forth.

The test evaluator 102 determines from the test exercise indicators 116 the quantity of transactions, Test_j_Transactions, experienced by program component k due to application of test j. The test evaluator 102 generates the score, Score(j, k), based on a difference between Test_j_Transactions and Baseline_Transactions. For example, Score(j, k) can be equal to the difference between Test_j_Transactions and Baseline_Transactions, or can be equal to the difference between Test_j_Transactions and Baseline_Transactions divided by a scaling factor, such as Baseline_Transactions.

In a specific example, assuming tests 1 and 2 in prior test runs 112 were applied against program component k in the computing system 108. A score, Score(1, k), can be computed based on a difference between Test_1_Transactions (the quantity of transactions experienced by program component k due to application of test 1) and Baseline_Transactions, and a Score(2, k), can be computed based on a difference between Test_2_Transactions (the quantity of transactions experienced by program component k due to application of test 2) and Baseline_Transactions. In some examples, if Test_2_Transactions>Test_1_Transactions, then Score(1, k)>Score(2, k).

In other examples, instead of assigning numerical scores based on a deviation of Test_j_Transactions from Baseline_Transactions, the test evaluator 102 can assign categorical scores, such as low, medium, and high. For example, if the difference between Test_j_Transactions and Baseline_Transactions is less than a first threshold, then Score(j, k) is set to “low”; if the difference between Test_j_Transactions and Baseline_Transactions is between the first threshold and a second threshold, then Score(j, k) is set to “medium”; and if the difference between Test_j_Transactions and Baseline_Transactions is greater than the second threshold, then Score(j, k) is set to “high.” There may be more categorical levels that can be assigned Score(j, k) in other examples.

In an example, it is assumed there are M program components, where M is a positive integer representing a quantity of program components 110. For a test j (j selected from among 1 to N, where N is a positive integer representing a quantity of tests that can be run in the computing system 108), the test evaluator 102 can compute a set of scores for program component k: {Score(j, 1), Score(j, 2), . . . , Score(j, M)}. This set of scores can make up a set of tags 118 for test j. More generally, the test evaluator 102 can compute a score, Score(j, k), for each combination of test j (j selected from 1 to N) and program component k (k selected from 1 to M).

In other examples, instead of or in addition to generating scores representing usefulness of tests to program components 110 based on quantities of transactions, the scores can be based on status indicators received from the program components 110. The status indicators may include status codes (also referred to as “response codes”). For example, some status codes produced by a program component under test may indicate negative results (e.g., due to an error or some other undesirable behavior of a program component) and other status codes may indicate positive results (e.g., due to no errors being produced or the program component running to completion within a time threshold). In other examples, a test may be designed to provoke a failure of a program component. Such a test may be referred to as a “failure-inducing test.” In such latter examples, a positive result would be indicated by a status code specifying that the program component failed due to application of the failure-inducing test, and a negative result would be indicated by a status code specifying that the program component passed due to application of the failure-inducing test. Some tests may cause a program component to return more status codes than other tests. A first test causes a program component to return more status codes than a second test can be assigned a higher score than the second test.

As further examples, the test evaluator 102 can compute scores based on other characteristics indicated by the test exercise indicators 116, such as data traffic volumes communicated by a program component due to application of a test, processor cycles used by a program component due to application of a test, an error rate experienced by a program component due to application of a test, or other characteristics.

Although some examples assume that a set of tags 118 is generated by the test evaluator 102 for a given test j, in other examples, a set of tags is generated by the test evaluator 102 for a given program component k. In the latter examples, for the given program component k, the set of tags can indicate usefulness of different tests to the program component k.

Even more generally, instead of dividing tags into sets of tags for respective tests or program components, the test evaluator 102 can generate a collection of tags correlating different pairs of tests and program components. For example, the test evaluator 102 can generate a two-dimensional array of tags where each tag in the array represents a usefulness of a test to a program component.

In further examples, the test evaluator 102 may include a machine learning (ML) model 120 that can be used to generate the sets of tags 118. The ML model 120 can be trained to produce the tags based on a training data set. The ML model 120 once trained can receive the test exercise indicators 116 and produce the sets of tags 118 as an output.

The sets of tags 118 are provided by the test evaluator 102 as inputs to the test filter 104. In response to a change in the computing system 108, the test filter 104 selects a subset of tests (a single test or multiple tests) from a larger collection of candidate tests. The collection of candidate tests is represented by candidate tests information 122. The collection of candidate tests can include tests of the prior test runs 112 that were previously applied in the computing system 108.

A version control system 124 provides changed program components information 126 to the test filter 104. The changed program components information 126 identifies one or more program components 110 that have been changed. Program developers may upload changed program components to the version control system 124. For example, the version control system 124 can include a GitHub system, which is a platform to allow program developers to create, store, manage, and share programs. As program components 110 are updated, the GitHub system is updated with new versions of the program components 110. In other examples, other types of version control systems 124 can be used, such as GitLab, Bitbucket, and so forth.

In response to the changed program components information 126, the test filter 104 filters the candidate tests identified by the candidate tests information 122. The filtering is based on the sets of tags 118 and program component(s) that have been changed, as indicated by the changed program components information 126. The test filter 104 produces a subset of tests 128, which is a subset of the candidate tests identified by the candidate tests information 122. The subset of tests 128 can include a portion that is less than all of the candidate tests, or alternatively, the subset of tests 128 can include all of the candidate tests.

In an example, if the changed program components information 126 specifies that program component 3 has changed, then the test filter 104 can retrieve the following scores from the sets of tags 118: Score(1, 3), Score(2, 3), . . . , Score(N, 3). The test filter 104 can determine which of the scores satisfies a criterion. For example, the criterion can be a threshold. If Score(j, 3) (j selected from 1 to N) exceeds the threshold, then test j can be selected by the test filter 104 to include in the subset of tests 128.

As another example, the test filter 104 can compare the scores, Score(1, 3), Score(2, 3), . . . , Score(N, 3), and based on the comparison, the test filter 104 can select P tests with the highest scores, where P≥1. In this latter example, P is set in a policy that specifies how many tests are to be included in the subset of tests 128.

In further examples, given a subset of program components that have changed, the policy can specify the selection of a minimum quantity of tests sufficient to cover each changed program component of the subset of program components. For example, the policy can specify that for each program component of the subset of program components that have changed, one test is selected to test the program component.

In other examples, given a subset of program components that have changed, the policy can specify the selection of all tests that cover the subset of program components. For example, the scores in the sets of tags 118 can indicate which tests exercised each program component of the changed subset of program components. The test filter 104 can select all such tests that exercised each program component of the changed subset of program components. By adjusting the policy, a smaller or larger selection of tests can be made allowing an optimized tradeoff of risk versus resource usage.

More generally, if the changed program components information 126 specifies that a subset of program components (one program component or multiple program components) has changed, the test filter 104 retrieves, from the sets of tags 118, scores that are relevant to the changed subset of program components. The test filter 104 uses the scores to determine which tests to run for the changed subset of program components.

The test filter 104 provides the subset of tests 128 to the test executor 106, which applies (at 130) the subset of tests 128 to the computing system 108. The test executor 106 can trigger the execution of the tests of the subset of tests 128 in the computing system 108. For example, a test can be represented by a test object (e.g., a test file) containing code that when executed causes the test to be performed. The test executor 106 can send test objects representing the tests in the subset of tests 128 to the computing system for execution.

The test executor 106 monitors test results produced from the subset of tests 128 applied in the computing system 108. For example, during execution of the tests in the subset of tests 128, the test executor 106 can monitor which program components were exercised by the tests and the extent and/or result of exercising of the tests. The test executor 106 provides the test results 132 to the test evaluator 102.

The test results 132 provide feedback to the test evaluator 102 regarding the usefulness of the tests in the subset of tests 130 with respect to program components. The test evaluator 102 can update at least some tags in the sets of tags 118 based on the test results 132. For example, the test results 132 may indicate that a given test is more or less useful for a particular program component than indicated by a given tag in a set of tags 118. In this case, the test evaluator 102 can update the given tag. As a more specific example, the test results 132 can indicate that the given test caused the particular program component to fail. Based on detecting from the test results 132 that the particular program component failed due to application of the given test, the test evaluator 102 can adjust the given tag (e.g., adjust a score in the given tag) to indicate a higher usefulness of the given test to the particular program component.

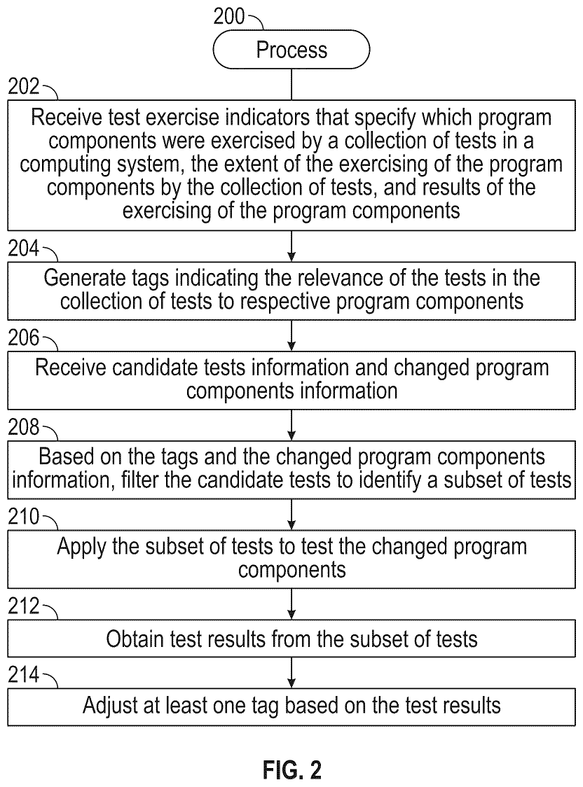

FIG. 2 is a flow diagram of a process 200 of a test filtering system according to some examples of the present disclosure. The test filtering system can include the test evaluator 102, the test filter 104, and the test executor 106 of FIG. 1, for example.

The process 200 includes receiving (at 202) test exercise indicators that specify which program components were exercised by a collection of tests in a computing system, the extent of the exercising of the program components by the collection of tests, and results of the exercising of the program components by the collection of tests. For example, the test exercise indicators can include the test exercise indicators 116 from the test coverage detector(s) 114. The collection of tests can include the tests in the prior test runs 112.

The process 200 includes generating (at 204) tags indicating the relevance of the tests in the collection of tests to respective program components of the computing system. The generated tags can include scores as discussed further above. For example, the generating can be performed by the test evaluator 102 of FIG. 1.

The process 200 includes receiving (at 206) candidate tests information (e.g., 122 in FIG. 1) specifying candidate tests that may be applied in the computing system, and changed program components information (e.g., 126 in FIG. 1) specifying one or more program components in the computing system that have changed.

Based on the tags and the changed program components information, the process 200 includes filtering (at 208) the candidate tests to identify a subset of tests. The filtering can be based on scores indicating usefulness of respective tests to corresponding program components. For example, the filtering can be performed by the test filter 104 of FIG. 1.

The process 200 includes applying (at 210) the subset of tests in the computing system, to test the changed program components. For example, the application of the subset of tests can be triggered by the test executor 106 of FIG. 1.

The process 200 includes obtaining (at 212) test results from the subset of tests performed in the computing system. For example, the test executor 106 can provide the test results 132 to the test evaluator 102 as feedback.

The process 200 includes adjusting (at 214) at least one tag of the tags based on the test results. The test results may indicate that a given test is more or less useful for a particular program component than indicated by a previously generated tag. In such an example, the value of the previously generated tag can be adjusted based on the test results.

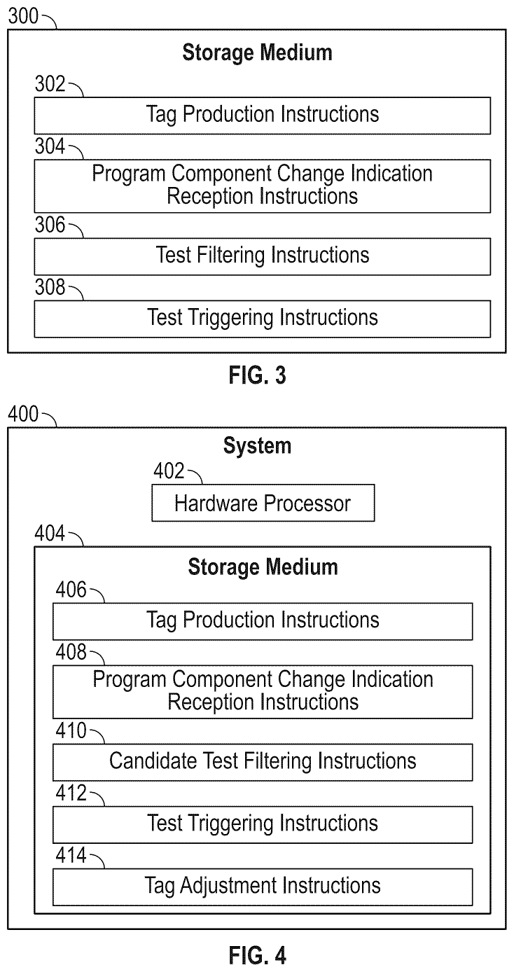

FIG. 3 is a block diagram of a non-transitory machine-readable or computer-readable storage medium 300 storing machine-readable instructions that upon execution cause a system to perform various tasks. The tasks may be performed by the test evaluator 102, the test filter 104, and the test executor 106 of FIG. 1, for example.

The machine-readable instructions include tag production instructions 302 to produce tags based on a plurality of tests run in a computing system in which program components are executable. Each tag indicates a relevance of a respective test to a corresponding program component in the computing system. In some examples, the tags include a set of tags indicating program components exercised by a respective test. In some examples, the tags include a set of tags indicating program components not exercised by a respective test. In further examples, each tag can include a score indicative of a usefulness of a test to a program component. For example, the score includes a probability score, where a higher probability score indicates a higher usefulness of a first test to the program component as compared to a second test assigned a lower probability score.

The machine-readable instructions include program component change indication reception instructions 304 to receive an indication of at least one changed program component from among a plurality of program components executable in the computing system. The indication can be provided by the version control system 124 of FIG. 1, for example.

The machine-readable instructions include test filtering instructions 306 to filter the plurality of tests based on the tags and the at least one changed program component to identify a subset of tests from among the plurality of tests. In an example, the filtering includes evaluating scores in the tags and identifying the subset of tests with scores that satisfy a criterion.

The machine-readable instructions include test triggering instructions 308 to trigger performance of the subset of tests in the computing system. For example, the subset of tests may be triggered by the test executor 106 of FIG. 1.

In some examples, the machine-readable instructions can receive information from a test coverage detector (e.g., 114 in FIG. 1) indicating which program components were exercised when a first test of the plurality of tests was run. The machine-readable instructions can generate, based on the received information, a first set of tags to associate with the first test, the first set of tags indicating a collection of program components exercised by the first test.

In some examples, the machine-readable instructions can set a tag in the first set of tags based on information relating to exercising of a respective program component of the collection of program components by the first test.

In some examples, the information indicates an extent or a result of the exercising of the respective program component by the first test.

In some examples, the information indicates a deviation of an activity of the respective program component caused by the first test from a baseline activity of the respective program component. The machine-readable instructions can set the tag based on the deviation.

In some examples, the information indicates an execution status of the respective program component due to application of the first test. The machine-readable instructions can set the tag based on the execution status. For example, the execution status of the respective program component is indicated by one or more status codes returned by the respective program component under test.

In some examples, the machine-readable instructions can receive test results based on performing the subset of tests, and update at least one tag of the tags based on the test results.

In some examples, the machine-readable instructions can detect that the first test caused the respective program component to fail. Based on detecting that the respective program component failed due to application of the first test, the machine-readable instructions can adjust the score to indicate a higher usefulness of the first test to the respective program component.

In some examples, the filtering of the plurality of tests to identify the subset of tests is based on a policy specifying how many tests to include in the subset of tests as part of the filtering. For example, the policy selects a minimum quantity of tests sufficient to cover each changed program component of the at least one changed program component. As another example, the policy selects all tests that cover the at least one changed program component.

FIG. 4 is a block diagram of a system 400 according to some examples. The system 400 can be implemented with one or more computers.

The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions that are executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include tag production instructions 406 to produce tags based on prior tests run in a computing system including program components. Each tag can include a score indicating a usefulness of a respective test to a corresponding program component in the computing system.

The machine-readable instructions in the storage medium 404 include program component change indication reception instructions 408 to receive an indication of at least one changed program component from among a plurality of program components executable in the computing system. A program component may be changed due to an update of the program component.

The machine-readable instructions in the storage medium 404 include candidate test filtering instructions 410 to filter a plurality of candidate tests based on scores in the tags and the at least one changed program component to identify a subset of tests from among the plurality of candidate tests. The filtering can determine which scores satisfy a criterion.

The machine-readable instructions in the storage medium 404 include test triggering instructions 412 to trigger performance of the subset of tests in the computing system. The machine-readable instructions in the storage medium 404 include tag adjustment instructions 414 to, based on test results of the subset of tests in the computing system, adjust at least one tag of the tags.

In some examples, the tags are produced by a machine learning model based on test exercise indicators received from one or more test coverage detectors that monitor how the prior tests exercise respective program components.

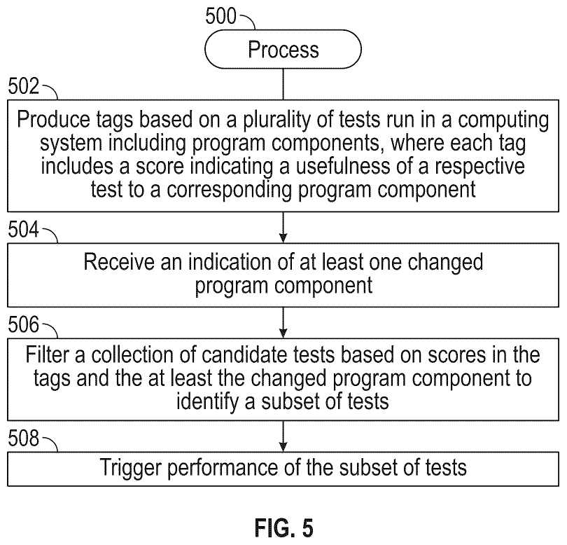

FIG. 5 is a flow diagram of a process 500 according to some examples of the present disclosure. The process 500 includes producing (at 502) tags based on a plurality of tests run in a computing system including program components, where each tag of the tags includes a score indicating a usefulness of a respective test to a corresponding program component in the computing system, the score being based on an extent or result of an exercise of the corresponding program component by the respective test.

The process 500 includes receiving (at 504) an indication of at least one changed program component from among a plurality of program components executable in the computing system. The indication may be provided by the version control system 124 of FIG. 1, for example.

The process 500 includes filtering (at 506) a collection of candidate tests based on scores in the tags and the at least one changed program component to identify a subset of tests from among the plurality of tests.

The process 500 includes triggering (at 508) performance of the subset of tests in the computing system.

In some examples, producing the tags includes setting a tag based on determining a deviation of an activity of a first program component caused by application of a given test to the first program component from a baseline activity of the first program component.

In some examples, producing the tags includes setting a tag based on an execution status of the first program component due to application of the given test.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
produce tags based on a plurality of tests run in a computing system comprising program components, wherein each tag of the tags indicates a relevance of a respective test to a corresponding program component in the computing system;
receive an indication of at least one changed program component from among a plurality of program components executable in the computing system;
filter the plurality of tests based on the tags and the at least one changed program component to identify a subset of tests from among the plurality of tests; and
trigger performance of the subset of tests in the computing system.

2. The non-transitory machine-readable storage medium of claim 1, wherein the tags comprise a set of tags indicating program components exercised by the respective test.

3. The non-transitory machine-readable storage medium of claim 1, wherein the tags comprise a set of tags indicating program components not exercised by the respective test.

4. The non-transitory machine-readable storage medium of claim 1, wherein the instructions upon execution cause the system to:
receive information from a test coverage detector indicating which program components were exercised when a first test of the plurality of tests was run; and
generate, based on the received information, a first set of tags to associate with the first test, the first set of tags indicating a collection of program components exercised by the first test.

5. The non-transitory machine-readable storage medium of claim 4, wherein the instructions upon execution cause the system to:
set a respective tag in the first set of tags, the respective tag set based on information relating to exercising of a respective program component of the collection of program components by the first test.

6. The non-transitory machine-readable storage medium of claim 5, wherein the information indicates an extent or a result of the exercising of the respective program component by the first test.

7. The non-transitory machine-readable storage medium of claim 5, wherein the information indicates a deviation of an activity of the respective program component caused by the first test from a baseline activity of the respective program component, and wherein the instructions upon execution cause the system to set the respective tag based on the deviation.

8. The non-transitory machine-readable storage medium of claim 5, wherein the information indicates an execution status of the respective program component due to application of the first test, and wherein the instructions upon execution cause the system to set the respective tag based on the execution status.

9. The non-transitory machine-readable storage medium of claim 8, wherein the execution status of the respective program component is indicated by one or more status codes returned by the respective program component.

10. The non-transitory machine-readable storage medium of claim 5, wherein the setting of the respective tag comprises setting a score indicative of a usefulness of the first test to the respective program component.

11. The non-transitory machine-readable storage medium of claim 10, wherein the score comprises a probability score, wherein a higher probability score indicates a higher usefulness of the first test to the respective program component as compared to a second test assigned a lower probability score.

12. The non-transitory machine-readable storage medium of claim 10, wherein the instructions upon execution cause the system to:
receive test results based on performing the subset of tests; and
update at least one tag of the tags based on the test results.

13. The non-transitory machine-readable storage medium of claim 10, wherein the instructions upon execution cause the system to:
detect that the first test caused the respective program component to fail; and
based on detecting that the respective program component failed due to application of the first test, adjust the score to indicate a higher usefulness of the first test to the respective program component.

14. The non-transitory machine-readable storage medium of claim 1, wherein the filtering of the plurality of tests to identify the subset of tests is based on a policy specifying how many tests to include in the subset of tests as part of the filtering.

15. The non-transitory machine-readable storage medium of claim 14, wherein the policy selects a minimum quantity of tests sufficient to cover each changed program component of the at least one changed program component.

16. The non-transitory machine-readable storage medium of claim 14, wherein the policy selects all tests that cover the at least one changed program component.

17. A system comprising:
a hardware processor; and
a non-transitory machine-readable storage medium storing instructions executable on the hardware processor to:
produce tags based on prior tests run in a computing system comprising program components, wherein each tag of the tags comprises a score indicating a usefulness of a respective test to a corresponding program component in the computing system;
receive an indication of at least one changed program component from among a plurality of program components executable in the computing system;
filter a plurality of candidate tests based on scores in the tags and the at least one changed program component to identify a subset of tests from among the plurality of candidate tests;
trigger performance of the subset of tests in the computing system; and
based on test results of the subset of tests in the computing system, adjust at least one tag of the tags.

18. The system of claim 17, wherein the tags are produced by a machine learning model based on test exercise indicators received from one or more test coverage detectors that monitor how the prior tests exercised respective program components.

19. A method comprising:
producing, by a system comprising a hardware processor, tags based on a plurality of tests run in a computing system comprising program components, wherein each tag of the tags comprises a score indicating a usefulness of a respective test to a corresponding program component in the computing system, the score being based on an extent or result of an exercise of the corresponding program component by the respective test;
receiving, by the system, an indication of at least one changed program component from among a plurality of program components executable in the computing system;
filtering, by the system, a collection of candidate tests based on scores in the tags and the at least one changed program component to identify a subset of tests from among the plurality of tests; and
triggering, by the system, performance of the subset of tests in the computing system.

20. The method of claim 19, wherein the producing of the tags comprises:
set a tag of the tags based on determining a deviation of an activity of a first program component caused by application of a given test to the first program component from a baseline activity of the first program component, or
set the tag based on an execution status of the first program component due to application of the given test.
